(19) United States
(12) Patent Application Publication
(10) Pub. No.: US 2025/0238496 A1
(43) Pub. Date: Jul. 24, 2025

(54) METHOD FOR SECURING SECURITY TOKEN AND SMARTCARD INTO PROCESSING DEVICE, AND SYSTEM, TERMINAL AND COMPUTER-READABLE MEDIUM FOR THE SAME

(71) Applicant: X70.IO LTD., Garden City, Hertforshire (GB)

(72) Inventor: Benjamin Smyth, Paris (FR)

(73) Assignee: X70.IO LTD., Garden City, Hertforshire (GB)

(21) Appl. No.: 18/711,576

(22) PCT Filed: Nov. 17, 2022
(86) PCT No.: PCT/US2022/050321

§ 371 Date: May 17, 2024

Related U.S. Application Data
(60) Provisional application No. 63/280,602, filed on Nov. 17, 2021.
(60) Provisional application No. 63/281,071, filed on Nov. 18, 2021.

(51) Int. Cl. G06F 21/34

(52) U.S. Cl. CPC G06F 21/34

(57) ABSTRACT

A method includes establishing a communicative connection between a first processing device and a second processing device, receiving a request at the first processing device, the request sent from the second processing device via the communicative connection, and processing by a cryptology portion of the first processing device, the processing by the cryptology portion of the first processing device including one or more secrets. The method further includes receiving the one or more secrets at a cryptology portion of the second processing device, processing data associated with the request, by the cryptology portion of the first processing device, the cryptology portion operative to process a result buy emulating a processing device on the cryptology portion of the first processing device to generate a reply, and sending the reply from the first processing device to the second processing device.

### TECHNICAL FIELD

This disclosure relates to data exchanges, and more specifically, to secured transfers of data to processing devices.

### BACKGROUND

Many security, identification, and transactional devices have inconvenient form factors. For example, smart cards consume space in a wallet or bag, while key fobs clutter keychains and can be difficult to operate. Such devices are generally used for storing secret data that has little use in processing interactions. In some instances, the devices store the secret data on a third-party server, which may exhibit connectivity problems or delays. Such methods may also be prone to security risks.

Teuwen et al. (U.S. Pat. No. 10,147,086) propose a reconfigurable digital wallet device similar to a smartcard device that is managed and synchronized with a virtual wallet stored in the cloud. Teuwen teaches a digital card such as a smart card that acts as the virtual wallet and may connect to a data network.

Lamfalusi et al. (U.S. Pat. No. 9,460,322) propose a point-of-sale device that communicates with a smart card and a payment processing service. The device may output and receive from multiple channels. The channels facilitate communication between a local vendor and a financial provider.

It would be desirable to improve storage of, or other interaction(s) with, data on secure device(s). It alternately or additionally would be desirable to improve storage of, or other interaction(s) with, data on identification device(s). It alternately or additionally would be desirable to improve storage of, or other interaction(s) with, data on transactional device(s).

### SUMMARY

A method includes one or more of, establishing a communicative connection between a first processing device and a second processing device, receiving a request at the first processing device, the request sent from the second processing device via the communicative connection, and processing by a cryptology portion of the first processing device, the processing by the cryptology portion of the first processing device including one or more secrets. The method optionally further includes receiving the one or more secrets at a cryptology portion of the second processing device, processing data associated with the request, by the cryptology portion of the first processing device, the cryptology portion operative to process a result buy emulating a processing device on the cryptology portion of the first processing device to generate a reply, and sending the reply from the first processing device to the second processing device.

A method for data processing includes one or more of, establishing a first communicative connection between a first processing device and a second processing device, receiving a request at the first processing device, the request sent from the second processing device via the first communicative connection, and processing by a cryptology portion of the first processing device, the processing by the cryptology portion of the first processing device including one or more secrets. The method optionally further includes processing data associated with the request, by the cryptology portion of the first processing device, the cryptology portion operative to process a result by emulating a processing device on the cryptology portion of the first processing device to generate a reply, the reply is efficiently generated using the one or more secrets and sending the reply from the first processing device to the second processing device.

A method for data processing includes one or more of, outputting data from a processor of a first processing device to a first cryptology portion responsively receiving a response from the first cryptology portion at the processor of the first processing device the first cryptology portion operative to generate the response with the processor of the first processing device, the first processing device operative to process the response by emulating a processing device on the cryptology portion of the first processing device, sending the response from the first processing device to a second processing device, and evaluating the result by the second processing device.

A method for data processing includes one or more of, establishing a communicative connection between a first processing device and a second processing device, processing a request at the first processing device, the request sent from the second processing device via the communicative connection, processing by a cryptology portion of the first processing device, the processing by the cryptology portion of the first processing device including one or more secrets, and processing the one or more secrets at a cryptology portion of the second processing device. The method optionally further includes processing data associated with the request, by the cryptology portion of the first processing device, the cryptology portion operative to process a result by emulating a processing device on the cryptology portion of the first processing device to generate a reply, the reply being operative to identify the first processing device, the evaluation of the reply by the second device includes evaluating whether the one or more secrets were used in generating the reply to establish the identity of the cryptology portion of the first processing device, and sending the reply from the first processing device to the second processing device.

Additional or alternative aspects of the disclosure are found in the appended claims. Further aspects, embodiments, features, and advantages of the embodiments, as well as the structure and operation of various embodiments are described in detail below with reference to the accompanying drawings.

### BRIEF DESCRIPTION OF THE DRAWINGS

In the accompanying drawings, which form a part of the specification and are to be read in conjunction therewith, and in which like reference numerals are used to indicate like features in the various views:

FIG. 1 illustrates a block diagram of a processing device according to embodiments;

FIG. 2 illustrates a block diagram of a system having a first processing device communicatively connected to a second processing device, according to embodiments;

FIG. 3 illustrates a block diagram of a method for operating a processing device, according to embodiments;

FIG. 4 illustrates devices in a system, according to embodiments;

FIG. 5 illustrates a block diagram of an exemplary method for performing methods of data transfer, according to embodiments;

FIG. 6 illustrates a block diagram of a system according to embodiments;

FIG. 7 illustrates a block diagram of a method of operation according to embodiments; and

FIG. 8. illustrates a data flow diagram according to embodiments.

### DETAILED DESCRIPTION

The use of physical smart cards, key fobs or other similar devices generally used to facilitate electronic identifications or transactions has become a burden on users and providers. Smart cards can include devices having many purposes, uses, and form factors, for example, security tokens that may include smart cards, access cards, credit cards, debit cards, loyalty cards, membership cards, one-time password generators, and travel cards. Other items include securing tokens such as, for example, single-use password generators, and building access and vehicle key fobs. These objects are often difficult to carry, and are easy to misplace, which may also incur a financial burden on the user or the company associated with the device due to production and distribution costs of the smart cards.

These devices may store secret data on third-party servers, which increases business risk and security. In some cases, such systems may release sensitive metadata about the user. Such systems also tend to fail when a communicative connection between devices is lost. Such systems may include, for example, functions such as wireless point of sale devices, on-line purchasing or commerce functions, and other features that may, for example, store sensitive information such as credit card or other information stored in software.

The embedded universal integrated circuit card (eUICC) is a next generation SIM (subscriber identity module) that is backwards compatible with older SIM cards known as universal integrated circuit cards (UICC). An embedded SIM (eSIM) architecture couples an eUICC with a subscription management (SM). An eSIM substantially includes an eUICC in addition to a SM.

Regarding an eUICC, a profile may be remotely injected into a eUICC over a communicative connection such as, for example, a wired or wireless communication connection. A SM remotely injects a profile into an eUICC over a communicative connection. The eUICC and the UICC are intended to store a profile that can be used to identify and authorize a processing device such as, for example, a smartphone. A profile is generally static and installed in a UICC by the manufacture or a network operator among others. Such an installation may occur before or after the UICC is installed inside a processing device.

SM platforms may inject a profile into a eUICC over a communicative connection, or optionally, using a communicative connection with a local profile assistant (LPA) module arranged on the communicative device. In an improvement to UICC an eUICC may store multiple profiles. The profiles may be managed over a wired or wireless communicative connection. Such management may include updating or deleting profiles.

The technology disclosed herein provides for the integration of smart cards and security tokens into mobile and other types of processing devices such as, for example, mobile phones or smartphones, key fobs, point of sale (POS) locations, vehicle and other entry systems.

The technology allows data besides profile data to be injected over-the-air such as through a wireless communications connection to a eUICC which includes data stored in smartcards and security tokens and other data not stored in SIMs.

Such a technology may reduce the need for smartcard enrollment procedures, with automated enrollment at the point of sale. Such an arrangement may reduce a demand for point of sale terminals, with smartphones or other mobile devices fulfilling the roll of point of sale terminals. This arrangement enables Chip-and-PIN over the internet, thus, removing point of sale terminals, and offering enhanced security for Internet transactions, thereby reducing costly fraud.

The technology includes sending data in addition to sending profiles. Such data may include data previously stored in, for example, a smartcard or a security token. Thus, more data than may be stored by a SIM.

The processing may also include communications and the exchange of data with a third-party such as, for example, a server of a financial institution or another third-party.

A smartphone and an eUICC may perform computations or logic where the smartphone and the eUICC exchange computational data where some of the sensitive or secret data remains in a cryptology portion of the processing device. Computational data output following the processing of data by the processor and the cryptology portion following receipt of the data by the processing device may be output to a third-party.

The processors and cryptology portions of the devices described herein are operative to perform logical computations that can include, for example, interaction with a user by receiving an input from the user. The logical computations include collecting a user's biometrics, personal identification number, or other identifying information.

The data stored on the eUICC may include data previously stored on access, loyalty, membership, or other similar cards. In operation, the secret data may be remotely injected over-the-air e.g., a wireless or wired connection to be stored by a crypto processor, rather than being imbedded during a physical or near field interaction with a smartcard or a security token, the crypto processor may emulate or virtualize the eUICC or other secure cards.

Vehicle key fobs are devices that are often linked mechanically to a key chain or other similar accessory. Key fobs may be used by being proximate to a location such as, for example, a vehicle or access point. Other key fobs may be activated with the use of buttons or other user inputs. The key fob may be emulated or virtualized by a processing device that may offer a display indicative of button or other choices for the user.

The systems described herein may operate with a user via user inputs or operate independently of input from a user.

In some instances an enrollment procedure can follow a failed transaction. Data injection my occur before, during, or after the enrollment procedure and a transaction may be reattempted.

One aspect of security is achieved by integrating smart cards and security tokens into smartphones, which would make such an arrangement less susceptible to loss or fraud. Further security may include receiving inputs from a user of the processing device, such as, for example, inputs into a touch display, buttons, biometrics or any other type of input device, thereby increasing the security of the data exchange by establishing an identity of a user.

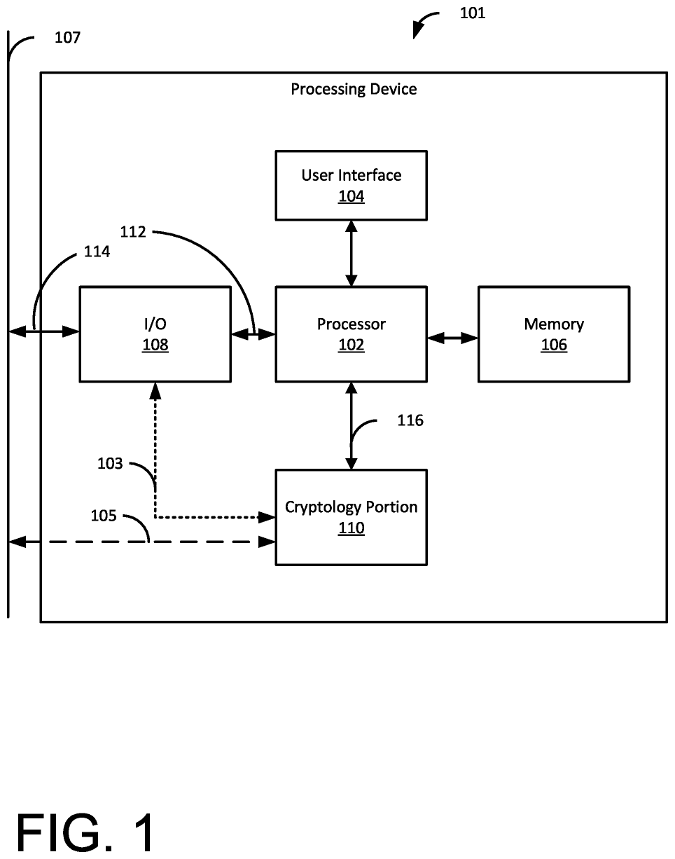

FIG. 1 illustrates a block diagram of embodiments of a processing device (mobile processing device) 101. In embodiments, the processing device 101 may be, for example, a smartphone, a terminal, a computer, a key fob, or any other suitable mobile or substantially stationary device.

The processing device 101 includes a processor 102. The processor 102 may include any suitable processor such as, for example, a system on a chip, an field programable gate array, or a discrete processing arrangement that is operative to perform logical functions, run an operating system or firmware, and in some instances, additional software to receive process and output data or other information logically through an input/output device or user interface device.

The processor 102 is communicably connected to a user interface 104, a memory 106, an input/output (I/O) (communication interface) 108 and a cryptology portion 110. The user interface 104 may include any suitable user interface such as, for example, a touch screen, a display screen, a button, camera, biometric data collection device, auditory device, behavioral device. The processing device 101 may include antennas, processors, memory, accelerometers, gyroscopes, microphones, or other sensors operative to collect in input from a user. The memory 106 provides data storage and may include any suitable type of memory such as disk or flash memory for storing data. In embodiments, the cryptology portion 110 may be physically located inside or on the processor 102 chip.

In embodiments, the cryptology portion 110 is operative to access secret data. The cryptology portion 110 may include, for example, a eUICC that accesses secret data that the processor 102 may not access. The cryptology portion 110 is operative to perform computations for cryptography that may include secret data, including, but not limited to, computations involving a secret key (e.g., symmetric encryption/decryption, HMACs) for tamper resistance since the cryptology portion 110 is often more resistant to malicious tampering than the processor portion 102.

Comparing the cryptology portion 110 to the processor 102, the processor 102 often has more computation power with respect to instruction sets than the cryptology portion 110.

The processor 102 may perform computations for cryptography, often when such computations do not involve secret data, including, but not limited to, computations involving a public key (e.g., public key encryption and digital signature verification, or computing a hash).

In embodiments, Direct Anonymous Attestation is an example of the system where sensitive operations are performed by a Trusted Platform Module (TPM) (e.g., the cryptology portion 110, and non-sensitive operations are performed by the processor 102. The division of processes between the cryptology portion 110 and the processor 102 promotes efficiency (processors are typically more powerful and have a more general instruction set), without leaking sensitive data to the processor, as such, Direct Anonymous Attestation proves that a TPM has been used. Direct Anonymous Attestation attempts to offload all non-sensitive computations to the processor.)

In embodiments of a flow path for a signal, packet, or other form of data is shown by the wired or secure connection 114, the I/O 108, the connection 112, the processor 102, the connection 116, and the cryptology portion 110. The connections 112 and 116 may include, for example, interconnects in the processing device 101.

In embodiments, the flow path from the secure connection 114, to the I/O 108, the connection 112 and the processor 102 may terminate at the processor 102, where the processor 102 may communicate with the cryptology portion 110 via another communicative connection.

In the embodiments, two additional data flow paths may be used in embodiments of the processing device 101. In this regard, a communicative link 103 may communicatively connect the cryptology portion 110 to the I/O 108. In embodiments the cryptology portion 110 has a communicative link 105 between the cryptology portion and a network or networked device via, for example, a wired or wireless connection to a network such as the Internet 107.

In embodiments described above, a method of using a cryptology portion and a processor to exchange data to generate a result following a request are shown. A result may include, for example, a privilege, right, authorization, or verification. Such a method may use sensitive and unsensitive data. The sensitive data may be stored and processed by the crypto processor while the unsensitive data is processed at least partially, by the processor. The processor collects outputs from the cryptology portion to generate a response. In embodiments the cryptology portion may receive and process unsensitive data.

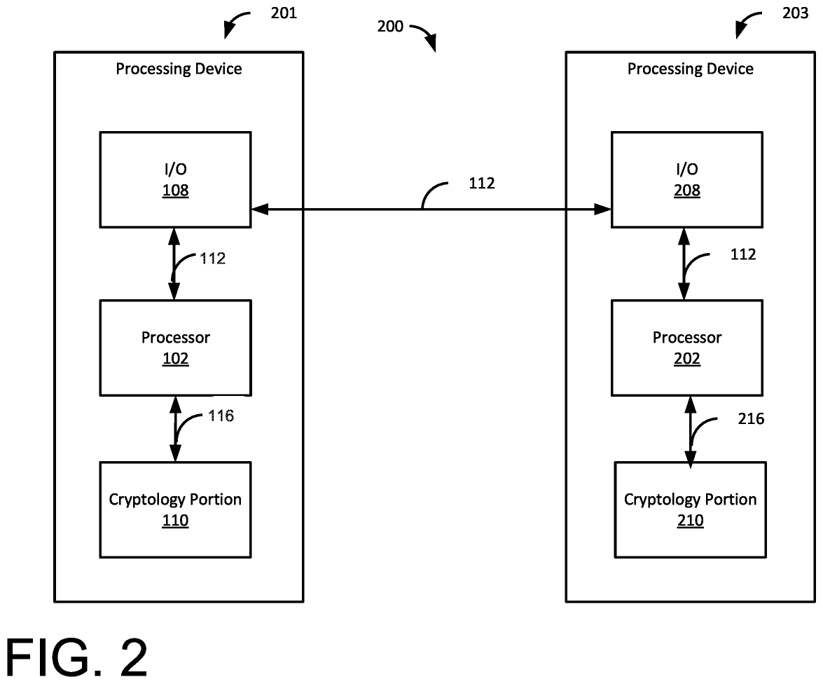

FIG. 2 illustrates a block diagram of a system 200 having a first processing device (e.g., a mobile processing device) 201 communicatively connected to a second processing device (e.g., mobile processing device) 203 via a signal 112. The processing devices 201 and 203 may include any type of suitable device such as, for example, a smartphone or other device having an I/O, processing, and cryptology portion. In this regard, the first processing device 201 includes a processor 102 communicatively connected to a cryptology portion 110 and an I/O portion 108, the cryptology portion may be connected to the processor 102 by the connection 116. The second processing device 203 includes any suitable processing device such as those described above with respect to processing device 101 (of FIG. 1) namely, a processor 202 being communicatively connected to a cryptology portion 210 and an I/O portion 208. The cryptology portion 210 may be connected to the processor 202 with a connection 216.

Computations at 201 may involve sensitive data, whereas verification at 203 may, in embodiments, not include sensitive data. Computations may be performed to allow verification in block 203, and may be performed in embodiments, with or without the cryptology portion 110.

The I/O portions 108 and 208 may include any suitable I/O arrangement including antennas, receiver and transmitter elements, a processor and any other number of devices and modes of operation.

The cryptology portion 110 may include, for example, an eUICC that accesses secret data that the processor 102 may not access. The cryptology portion 110 is operative to perform computations for cryptography that may include secret data, including, but not limited to, computations involving a secret key (e.g., symmetric encryption/decryption, HMACs) for tamper resistance since the cryptology portion 110 is often more resistant to malicious tampering than the processor portion 102.

The signal 112 has a data flow path from the first processing device 201 to the second processing device 203 via a wired or wireless connection. The flow path of signal 112 begins at the first processing device 201 at the processor 102, then to the I/O 108. From the I/O 108 to I/O 208, the signal 112 is sent to the processing device 203.

The signal 112 may include a request from the processing device 203 to the processing device 201 to be processed by the processor 102. The processor 102 may send requests for data to the cryptology portion 110 via the connection 116. Once the processor 102 receives the responses from the cryptology portion 110, the processor 102 may generate a reply to requests from the processing device 203 using data processed by the processor and data received from the cryptology portion 110. The request or in some instances, the reply may include profile or additional data.

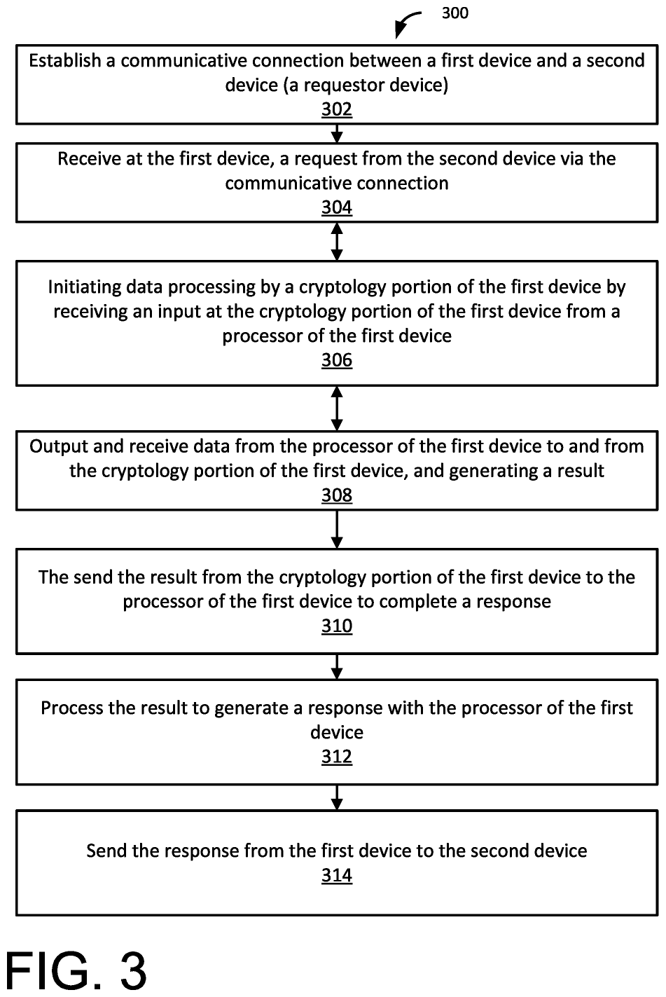

In embodiments, FIG. 3 illustrates a block diagram of a method 300 for operating the processing device such as the first processing device 201 (of FIG. 2) and a portion of the system 200. In this regard, in block 302, a connection is established between the first processing device 201 and the second processing device 203 using, for example, the I/Os 108 and 208, which are communicatively connected to the processors 102 and 202 respectively. The I/Os 108 and 208 may modify the message headers or perform other similar tasks when data is received.

In block 304, the first processing device 201 receives a request message (with request data) from the second processing device 203. The request message is sent from the processor 202 of the second processing device 203 to the to the processor 102.

The request message (e.g., an authentication request message) is sent by a processing device to another device such as, for example, an access card or key fob the authentication request message may include data that demonstrates a smartcard associated with the user permits the user access to, for example, a vehicle or building. The authentication request message may, in embodiments, include data that demonstrates that the user is associated with a particular account or accounts of a loyalty, membership, or travel card. In embodiments, the authentication request message may be operative to demonstrate that the user is associated with a smartcard that is associated with a contactless credit, debit, or charge card. In embodiments, transactions involving a personal identification number (PIN) the authentication request message may include data associated with or representing the PIN that may, in embodiments, be send with data associated with smartcards or similar devices. The authentication request message may also include details of a transaction (e.g., payment amount), a merchant identification, and other data operative to facilitate exchanges and operations.

Though the examples and explanations regarding the authentication request message are illustrated individually, any features of the authentication request message, in embodiments, may be included individually or in combination.

In block 306, the processor 102 is operative to send a signal or data to the cryptology portion 110 to initiate data processing by the cryptology portion 110. The data in the result may vary between the types of transactions that are performed by the devices. In embodiments, examples of results include, demonstrating association with a smartcard or token. Authenticating a portion of the request such as, for example, a transaction amount or a merchant identification.

In block 308, in embodiments, data is output by the processor 102 and received by the cryptology portion 110. Once the data is processed by the cryptology portion 110, the result is output to the processor 102, in block 310. Such a flow of data may be performed any number of times to generate a result.

In block 312, the processor 102 is operative to generate a reply partially or fully using, in many instances, the result of the data received by the cryptology portion 110.

A response is sent from the first mobile processing device 201 to the second mobile processing device 203 in block 314.

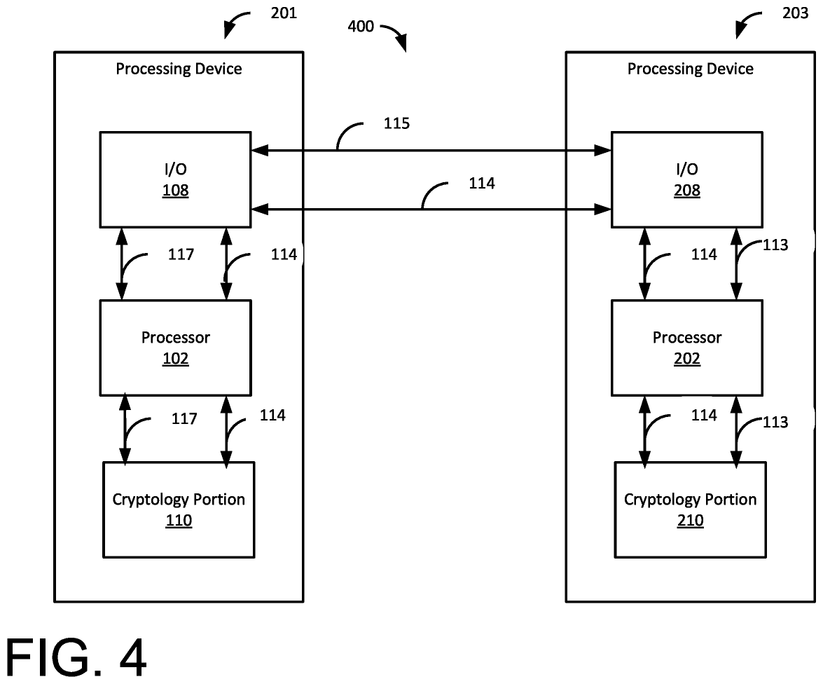

In embodiments, FIG. 4 illustrates processing devices 201 and 203 in a system 400. The processing devices 201 and 203 including the hardware within these devices is similar to the devices 201 and 203 described in detail above with respect to FIG. 2.

In embodiments, the processing device 201 includes the processor 102, the I/O 108, and the cryptology portion 110 of the processing device 201, which are connected by interconnects 114. The processing device 203 includes the processor 202 connected to the I/O 208 and the cryptology portion 210 by interconnects 113.

In operation, the cryptology portion 110 of the first processing device 201 may be communicatively connected to the cryptology portion 210 of the second processing device 203 via a secure end-to-end communicative connection (signal) (secure connection) 114 or via a non-secure or less secure communicative connection 115 between the I/O 108 and the I/O 208 may also be established by the system 400. The secure connection 114 has a flow path that flows from the cryptology portion 110 to the processor 102, and the I/O 108. In embodiments the cryptology portion 110 may be directly connected to the I/O 108. The path continues from the I/O 108 to the I/O 208 of the second processing device 203 over path 114. The secure connection 114 may be transmitted between the first processing device 201 and the second processing device 203 using, for example, a secure wired or wireless connection. The secure connection 114 flows through to the I/O 208 to the processor 202 to the cryptology portion 210. Thus, a secure end-to-end communicative connection is established between the cryptology portion 110 of the first processing device 201 and the cryptology portion 210 of the second processing device 203. The processor 202 is communicatively connected to the I/O 208 and the cryptology portion via connections 113, and the processor 102 is communicatively connected to the I/O 108 and the cryptology portion 110 via connections 117.

A secure end-to-end connection includes a data connection between an initiator and an interlocutor. The connection is made to prevent, for example, eavesdropping, tampering, and forgery. Such connections substantially improve, for example, the confidentially, integrity, and authentication of a secure end-to-end connection.

In embodiments, a secured end-to-end connection is used to initiate the cryptology portion 110 of the processing device 201 with secret data. In embodiments the secure end-to-end connection may not be used following the initiation of the cryptology portion 110 of the processing device 201 with secret data.

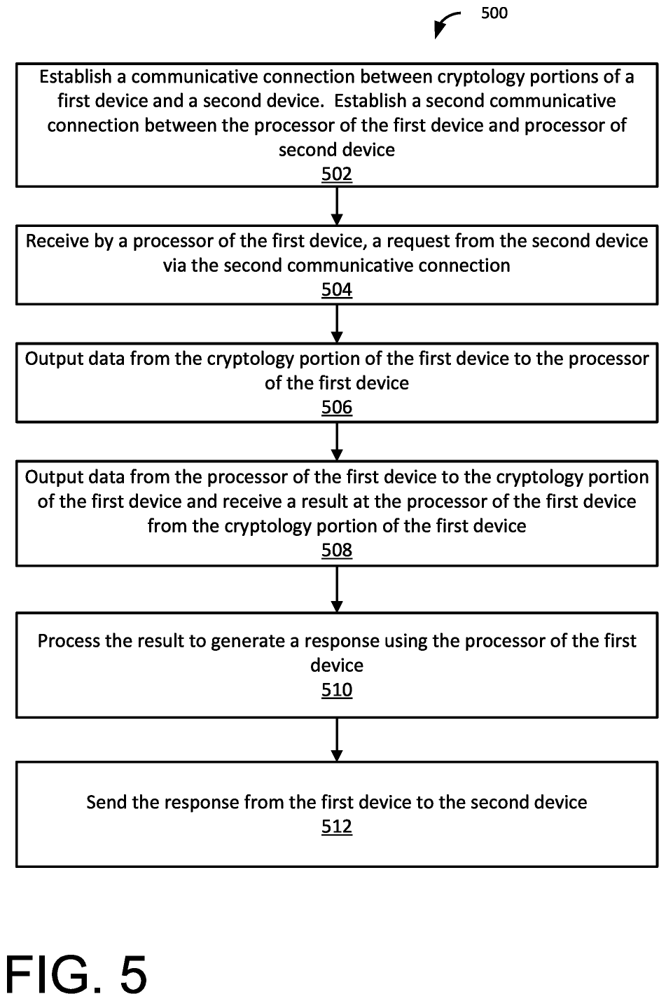

In embodiments, FIG. 5 shows a block diagram 500 a method for performing methods for data transfer. In this regard, in block 502 a secure communicative connection 114 (of FIG. 4) is established between the cryptology portion 110 of a first processing device 201 and a cryptology portion 210 of a second processing device 203. The secure connection 114 is a secure end-to-end communicative channel.

A secure end-to-end connection includes a data connection between an initiator and an interlocutor. The connection is made to prevent, for example, eavesdropping, tampering, and forgery. Such connections substantially improve, for example, the confidentially, integrity, and authentication of a secure end-to-end connection.

In embodiments, a secured end-to-end connection is used to initiate the cryptology portion 110 of the processing device 201 with secret data. In embodiments the secure end-to-end connection may not be used following the initiation of the cryptology portion 110 of the processing device 201 with secret data.

In block 504, a request is received by a processor 102 of the first processing device 201. The request sent by the second processing device 203 via the secure communicative connection or another suitable communicative connection. In operation in embodiments, the request may be sent by a less-secure or un-secure connection since sensitive information is often not included in requests. The response in embodiments often does not contain sensitive information and thus, may, for example be sent via a less-secure or un-secure communicative connection. In embodiments, the secure end-to-end connection 114 may be used in some request and responses if, for example, the requests or responses are to be verified, the response may include secret data. Such verification may be performed by, for example, the cryptology portion 210.

In block 506, data is output from the cryptology portion 110 of the first processing device 201 to the processor 102 of the first processing device 201.

In block 508, data is output from the processor 102 of the first processing device 201 to the cryptology portion 110. The cryptology portion 110 performs a calculation and outputs a result. The result is received by the processor 102 from the cryptology portion 110 of the first processing device 201.

In block 510, the processor 102 of the first processing device 201 processes the data received from the cryptology portion 110. The processor 102 in embodiments may process other data accessible by the processor 102 along with the data received from the cryptology portion 110 to generate a response.

The response is sent from the first processing device 201 to the second processing device 203 in block 512. The request or in some instances, the reply may include profile or additional data.

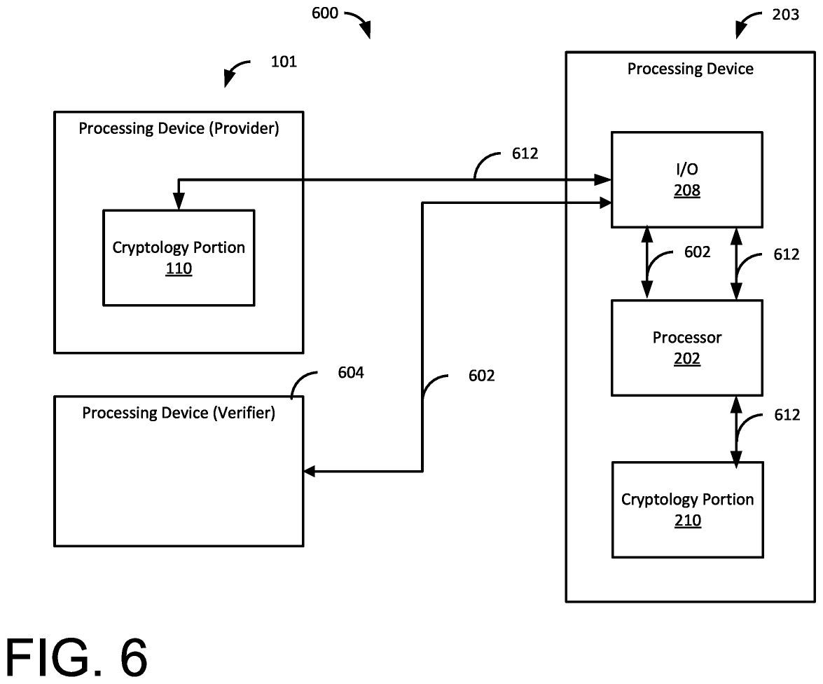

FIG. 6 illustrates a block diagram of a system 600. In embodiments, for the arrangement of FIG. 6, the cryptology portion 210 of the processing device 203 is communicatively connected to the cryptology portion 110 of the processing device 101. The cryptology portion 110 is communicatively connected to the I/O portion 208 via an end-to-end secure signal channel 612. A second communicative channel 602 is established between a third processing device (verifier) 604 and the processing device 203. The communicative connections 602 and 612 may be facilitated by the I/O portion 208 and an I/O portion of the processing device 101.

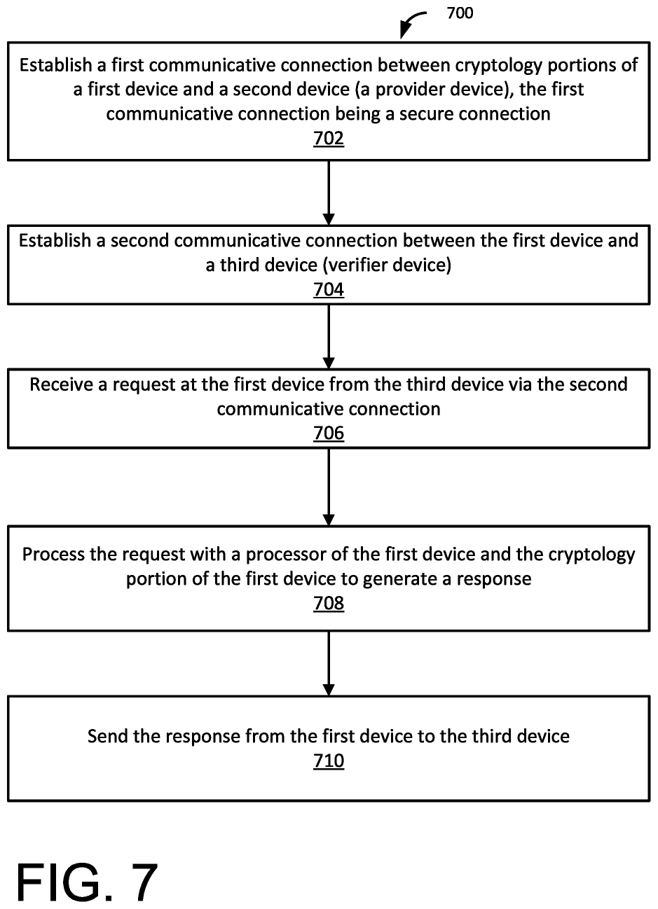

FIG. 7 illustrates a block diagram 700 of a method of operation in embodiments described herein including the system 600 (of FIG. 6). In block 702, a first communicative connection 612 is established between the cryptology portion 110 and the cryptology portion 210. The first communicative connection 612 is an end-to-end secure channel. A second communicative connection is established between a third processing device (verifier) 604 and the processing device 203 via a signal path indicated by the arrows 602 (of FIG. 6) in block 704. In embodiments, though the end-to-end secure signal channel 612 is shown, the end-to-end secure signal channel 612 is optional and may be omitted.

In block 706, the processing device 203 receives a request message from the third processing device 604.

In block 708, the processing device 203 processes the request by outputting and inputting data to and from the cryptology portion to generate a response. The response is sent by the processing device 203 to the processing device 101 or in some instances data may be sent to the processing device 604.

In block 710, the first device sends the response to the third device.

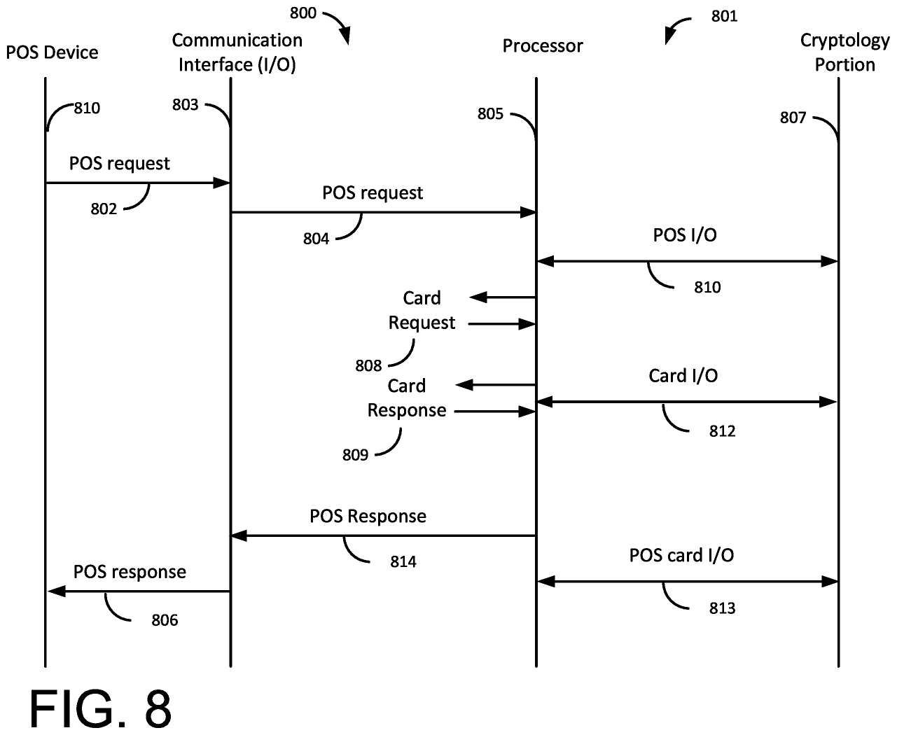

In embodiments, referring to FIG. 8, a data flow diagram 800 is shown having a processing device 801 that includes a processor 805 communicatively connected to a cryptology portion 807 and a communication interface (I/O) 803. The processing device 801 is communicatively connected to the point of sale (POS) device (terminal) 810.

In operation, secret data is embedded in a cryptology portion of a POS terminal, which may store the secret embedded secret data. The crypto processor may emulate a point of sale terminal. The crypto processor may also emulate a credit or debit card. Contact based touching or tapping credit or debit card transactions may also be emulated.

A POS request 802 is sent from the POS device 810 to the I/O 803 of the processing device 801. The request is processed in 808 and 809 by card request and response. The processor 805, in some instances, may send results to the cryptology portion 807. The processor 805 may send various data to the cryptology portion 807. In embodiments, a POS request 804 is sent from the I/O 803 to the processor. The processor 805 may process the request and send data to POS I/O 810 from the card request and response 808 and 809 to the processor portion 805. The cryptology portion 807 and the processor 805 may exchange data due to output card I/O 812 and POS card I/O 813. The response 814 is generated by the processor 805 using data from the cryptology portion 807 in some instances. The POS response 814 is sent from the processor 814 through the I/O 803 and the POS response 806 is sent to the POS device 810.

Data may be, for example, sent from a POS device to a smartcard via a conductive contact connected to or on the smartcard. In embodiments, the exchange of data between a POS device and a smartcard are emulated digitally such that data sent from a POS device may be received by a processing device, relayed to a processor, and then sent to a cryptology portion that behaves like or emulates the smartcard.

In embodiments, data processed that was previously processed by POS devices may be processed in the cryptology portion that behaves like or emulates the POS device. The data may be relayed to a processor and back to a cryptology portion that also may emulate the smartcard and perform processes that behave like or emulate a smart card.

The POS and card are emulated by the cryptology portion 807. The data may be relayed to a processor and back to a cryptology portion that also may emulate the smartcard and perform processes that behave like or emulate a smart card. The emulated POS processed in the cryptology portion 807 and the emulated card processed by the cryptology portion 807 may communicate with the processor 805. The processor 805 may relay communication between the emulated POS and the emulated card processed by the cryptology portion 807.

In embodiments described herein a system and method of storing and using data related to any number of devices including, for example, smart cards, electronic tokens, credit and debit cards, loyalty cards, key fobs, structure and vehicle access in a smartphone or other suitable processing device is provided for. In embodiments, portions of the processing may be performed, by, for example, smartphones. In embodiments the systems described herein are operative to increase the speed, security, and convenience of the described electronic data exchanges.

Another aspect of the disclosure is one or more computer-readable media (or computer storage apparatus) having a program, which when executed by one or more processors, such part of one or more of the systems described herein, causes the one or more processors to enable, allow or cause devices to perform any one of the methods as variously comprising any one or more of its various embodiments or sub-embodiments described above or otherwise covered by the appended claims.

In embodiments, the one or more computer-readable media are non-transitory media such as, but not limited to HDD and SSD disk drives, thumb and other flash drives, DVD's, CD's various static and dynamic storage devices and other numerous storage media.

In embodiments, the one or more computer-readable media comprise or are one or more transitory electronic signals.

The following numbered clauses set forth various embodiments of the disclosure:
0. A method, terminal, system, signal, or transitory or non-transitory computer readable medium according to any one or more of the preceding clauses,

1. At least one
(a) computer-implemented method,
(b) terminal,
   (i) comprising means for performing steps, or
   (ii) comprising software module(s) for performing operation(s), or
   (iii) comprising at least one processor; and at least one memory storing instruction(s) that, when executed by the at least one processor, cause the at least one processor to perform one or more steps,
(c) system, by way of
   (i) means for, or
   (ii) software module(s) for performing operation(s), or
   (iii) comprising at least one processor; and at least one memory storing instructions that, when executed by the at least one processor, cause the at least one processor to, or
(d) transitory or non-transitory computer-readable medium (or alternately also herein throughout, computer storage apparatus) containing instructions which when executed by one or more computers each or collectively comprising one or more processors cause operation(s), according to any one of the above or below clauses, the operation(s),
   optionally comprising:
establishing a communicative connection between a first processing device and a second processing device.

1.1 A method, terminal, system, signal, or transitory or non-transitory computer readable medium according to any one or more of the preceding clauses, further comprising receiving a request at the first processing device, the request sent from the second processing device via the communicative connection.

1.2 A method, terminal, system, signal, or transitory or non-transitory computer readable medium according to any one or more of the preceding clauses, further comprising processing by a cryptology portion of the first processing device, the processing by the cryptology portion of the first processing device including one or more secrets.

1.3 A method, terminal, system, signal, or transitory or non-transitory computer readable medium according to any one or more of the preceding clauses, further comprising processing data associated with the request, by the cryptology portion of the first processing device, the cryptology portion operative to process a result by emulating a processing device on the cryptology portion of the first processing device to generate a reply.

1.4 A method, terminal, system, signal, or transitory or non-transitory computer readable medium according to any one or more of the preceding clauses, further comprising sending the reply from the first processing device to the second processing device.

2. A method, terminal, system, signal, or transitory or non-transitory computer readable medium according to any one or more of the preceding clauses, further comprising the second processing device evaluating whether the one or more secrets were used in generating the reply to establish the identity of the cryptology portion of the first processing device.

3. A method, terminal, system, signal, or transitory or non-transitory computer readable medium according to any one or more of the preceding clauses, further comprising granting a privilege to a user.

4. A method, terminal, system, signal, or transitory or non-transitory computer readable medium according to any one or more of the preceding clauses, wherein the cryptology portion is operative to process a result by emulating a processing device on the cryptology portion.

5. A method, terminal, system, signal, or transitory or non-transitory computer readable medium according to any one or more of the preceding clauses, wherein the request includes an authentication request.

6. A method, terminal, system, signal, or transitory or non-transitory computer readable medium according to any one or more of the preceding clauses, wherein the cryptology portion of the first processing device is substantially separate from other processors on the first processing device.

7. A method, terminal, system, signal, or transitory or non-transitory computer readable medium according to any one or more of the preceding clauses, wherein the one or more secrets identify the first cryptology portion to the second processing device.

8. A method, terminal, system, signal, or transitory or non-transitory computer readable medium according to any one or more of the preceding clauses, wherein the first processing device includes a mobile processing device.

9. A method, terminal, system, signal, or transitory or non-transitory computer readable medium according to any one or more of the preceding clauses, further comprising evaluating the reply with a second cryptology portion arranged in the second processing device.

10. A method, terminal, system, signal, or transitory or non-transitory computer readable medium according to any one or more of the preceding clauses, further comprising sending the one or more secrets from the second processing device to the cryptology portion of the first processing device, wherein after sending the one or more secrets from the second processing device to the cryptology portion of the first processing device, the second processor performs computations ensuring the second processor can no longer process nor access the one or more secrets.

11. A method, terminal, system, signal, or transitory or non-transitory computer readable medium according to any one or more of the preceding clauses, wherein the one or more secrets are sent from the second processing device to the cryptology portion using a secure channel.

12. A method, terminal, system, signal, or transitory or non-transitory computer readable medium according to any one or more of the preceding clauses, wherein the cryptology portion includes an embedded universal integrated circuit card (eUICC).

13. A method, terminal, system, signal, or transitory or non-transitory computer readable medium according to any one or more of the preceding clauses, wherein the reply is operative to grant a privilege to a user.

14. A method for data processing, terminal, system, or transitory or non-transitory computer readable medium according to any one or more of the preceding clauses, comprising:
establishing a first communicative connection between a first processing device and a second processing device;
receiving a request at the first processing device, the request sent from the second processing device via the first communicative connection;
processing by a cryptology portion of the first processing device, the processing by the cryptology portion of the first processing device including one or more secrets;
processing data associated with the request, by the cryptology portion of the first processing device, the cryptology portion operative to process a result by emulating a processing device on the cryptology portion of the first processing device to generate a reply, the reply is efficiently generated using the one or more secrets; and
sending the reply from the first processing device to the second processing device.

15. A method, terminal, system, signal, or transitory or non-transitory computer readable medium according to any one or more of the preceding clauses, wherein the first processing device is a mobile device and the second processing device is a device operative to identify a user.

16. A method, terminal, system, signal, or transitory or non-transitory computer readable medium according to any one or more of the preceding clauses, wherein the first processing device is further operative to generate a reply identifying an account associated with the first processing device.

17. A method, terminal, system, signal, or transitory or non-transitory computer readable medium according to any one or more of the preceding clauses, further comprising establishing a second communicative connection between a processor of the first processing device and a processor of the second processing device; and receiving by the processor of the first processing device a request from the second processing device via the second communicative connection.

18. A method, terminal, system, signal, or transitory or non-transitory computer readable medium according to any one or more of the preceding clauses, wherein the cryptology portion is operative to process a result by emulating a processing device on the cryptology portion.

19. A method, terminal, system, signal, or transitory or non-transitory computer readable medium according to any one or more of the preceding clauses, or a method for data processing according to any one or more of the preceding clauses, comprising:
outputting data from a processor of a first processing device to a first cryptology portion responsively receiving a response from the first cryptology portion at the processor of the first processing device the first cryptology portion operative to generate the response with the processor of the first processing device, the first processing device operative to process the response by emulating a processing device on the cryptology portion of the first processing device;
sending the response from the first processing device to a second processing device; and
evaluating the result by the second processing device.

20. A method, terminal, system, signal, or transitory or non-transitory computer readable medium according to any one or more of the preceding clauses, wherein prior to generating a response with the processor of the first processing device, the method further includes:
processing by the cryptology portion of the first processing device one or more secrets;
sending the one or more secrets from a second processing device to the cryptology portion; and
performing a computation with such that at least one processor of the second processing device may not access the one or more secrets.

21. A method, terminal, system, signal, or transitory or non-transitory computer readable medium according to any one or more of the preceding clauses, or a method for data processing according to any one or more of the preceding clauses, comprising:
establishing a communicative connection between a first processing device and a second processing device;
processing a request at the first processing device, the request sent from the second processing device via the communicative connection;
processing by a cryptology portion of the first processing device, the processing by the cryptology portion of the first processing device including one or more secrets;
processing the one or more secrets at a cryptology portion of the second processing device;
processing data associated with the request, by the cryptology portion of the first processing device, the cryptology portion operative to process a result by emulating a processing device on the cryptology portion of the first processing device to generate a reply, the reply being operative to identify the first processing device, the evaluation of the reply by the second device includes evaluating whether the one or more secrets were used in generating the reply to establish the identity of the cryptology portion of the first processing device; and
sending the reply from the first processing device to the second processing device.

Embodiments can work with software, hardware, and/or operating system implementations other than those described herein. Any software, hardware, and operating system implementations suitable for performing the functions described herein can be used. Embodiments are applicable to both a client and to a server or a combination of both.

While it is apparent that the illustrative embodiments of the disclosure herein fulfil one or more objectives or inventive solutions, it is appreciated that numerous modifications and other embodiments may be devised by those skilled in the art. Additionally, feature(s) and/or element(s) from any embodiment may be used singly or in combination with other embodiment(s). Therefore, it will be understood that the appended claims are intended to cover all such modifications and embodiments that would come within the spirit and scope of the present disclosure.

The above embodiments are to be understood as illustrative examples of the disclosure. Further embodiments of the disclosure are envisaged. It is to be understood that any feature described in relation to any one or one set of embodiments may be used alone, or in combination with other features described, and may also be used in combination with one or more features of any other of the embodiments, or any combination of any other of the embodiments. Furthermore, equivalents and modifications not described above may also be employed without departing from the scope of the disclosure, which is defined in the accompanying claims.

What is claimed is:

1. A method for data processing, the method comprising:
establishing a communicative connection between a first processing device and a second processing device;
receiving a request at the first processing device, the request sent from the second processing device via the communicative connection;
processing by a cryptology portion of the first processing device, the processing by the cryptology portion of the first processing device including one or more secrets;
processing data associated with the request, by the cryptology portion of the first processing device, the cryptology portion operative to process a result by emulating a processing device on the cryptology portion of the first processing device to generate a reply; and
sending the reply from the first processing device to the second processing device.

2. The method of claim 1, further comprising the second processing device evaluating whether the one or more secrets were used in generating the reply to establish an identity of the cryptology portion of the first processing device.

3. The method of claim 1, further comprising granting a privilege to a user.

4. The method of claim 1, wherein the cryptology portion is operative to process a result by emulating a processing device on the cryptology portion.

5. The method of claim 1, wherein the request includes an authentication request.

6. The method of claim 1, wherein the cryptology portion of the first processing device is substantially separate from other processors on the first processing device.

7. The method of claim 1, wherein the one or more secrets identify the first cryptology portion to the second processing device.

8. The method of claim 1, wherein the first processing device includes a mobile processing device.

9. The method of claim 1, further comprising evaluating the reply with a second cryptology portion arranged in the second processing device.

10. The method of claim 1, further comprising sending the one or more secrets from the second processing device to the cryptology portion of the first processing device, wherein after sending the one or more secrets from the second processing device to the cryptology portion of the first processing device, the second processing device performs computations ensuring the second processor can no longer process nor access the one or more secrets.

11. The method of claim 10, wherein the one or more secrets are sent from the second processing device to the cryptology portion using a secure channel.

12. The method of claim 1, wherein the cryptology portion includes an embedded universal integrated circuit card (eUICC).

13. The method of claim 1, wherein the reply is operative to grant a privilege to a user.

14. A method for data processing, the method comprising:
establishing a first communicative connection between a first processing device and a second processing device;
receiving a request at the first processing device, the request sent from the second processing device via the first communicative connection;
processing by a cryptology portion of the first processing device, the processing by the cryptology portion of the first processing device including one or more secrets;
processing data associated with the request, by the cryptology portion of the first processing device, the cryptology portion operative to process a result by emulating a processing device on the cryptology portion of the first processing device to generate a reply, the reply is efficiently generated using the one or more secrets; and
sending the reply from the first processing device to the second processing device.

15. The method of claim 14, wherein the first processing device is a mobile device and the second processing device is a device operative to identify a user.

16. The method of claim 14, wherein the first processing device is further operative to generate a reply identifying an account associated with the first processing device.

17. The method of claim 14, further comprising establishing a second communicative connection between a processor of the first processing device and a processor of the second processing device; and
receiving by the processor of the first processing device a request from the second processing device via the second communicative connection.

18. The method of claim 14, wherein the cryptology portion is operative to process a result by emulating a processing device on the cryptology portion.

19. A method for data processing, the method comprising:
outputting data from a processor of a first processing device to a first cryptology portion responsively receiving a response from the first cryptology portion at the processor of the first processing device the first cryptology portion operative to generate the response with the processor of the first processing device, the first processing device operative to process the response by emulating a processing device on the cryptology portion of the first processing device;
sending the response from the first processing device to a second processing device; and
evaluating the response by the second processing device.

20. The method of claim 19, wherein prior to generating a response with the processor of the first processing device, the method further includes:
processing by the cryptology portion of the first processing device one or more secrets;
sending secrets from a second processing device to the cryptology portion; and
performing a computation with such that at least one processor of the second processing device may not access the one or more secrets.

21. A method for data processing, the method comprising:
establishing a communicative connection between a first processing device and a second processing device;
processing a request at the first processing device, the request sent from the second processing device via the communicative connection;
processing by a cryptology portion of the first processing device, the processing by the cryptology portion of the first processing device including one or more secrets;
processing the one or more secrets at a cryptology portion of the second processing device;
processing data associated with the request, by the cryptology portion of the first processing device, the cryptology portion operative to process a result by emulating a processing device on the cryptology portion of the first processing device to generate a response, the response being operative to identify the first processing device, the processing of the reply by the second device includes evaluating whether the one or more secrets were used in generating the reply to establish the identity of the cryptology portion of the first processing device; and
sending the response from the first processing device to the second processing device.
